(19) United States
(12) Patent Application Publication
(10) Pub. No.: US 2002/0125786 A1
(43) Pub. Date: Sep. 12, 2002

(54) Carbon brush assembly for electric tool

(76) Inventor: Wen Yao Chi, Feng Yuan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/795,130

(22) Filed: Mar. 1, 2001

(51) Int. Cl. H02K 13/00

(52) U.S. Cl. 310/239; 310/245; 310/242

(57) ABSTRACT

An improved carbon brush assembly for an electric tool, particularly an electric tool that utilizes electromagnetic force to drive a tool shaft. The carbon brush assembly includes a carbon brush, a carbon brush seat, a constant force spring and a cover. The carbon brush seat has the constant force spring fitted therein. The carbon brush always abuts against a plate portion of the constant force spring in the carbon brush seat. An electric tool housing is formed with a through hole corresponding to the carbon brush seat for passage of the carbon brush. A sunken space is formed around the through hole for embedding the carbon brush seat. The outer edge wall of the sunken space may just insertably grip the edge of the cover such that the cover forms a part of the housing after assembly to shield the carbon brush seat embedded in the housing. By virtue of the constant force spring, the carbon brush can be subjected to a more uniform biasing action to thereby prolong the service life of the carbon brush. A constant carbon brush pressure also can maintain proper contact between the carbon brush and a connecting portion to prevent poor electrical contact and generation of sparks. The cover is removable to permit removal of the carbon brush seat and the carbon brush from the housing for replacement.

### BACKGROUND OF THE INVENTION

(1) Field of the Invention

The present invention to an improved carbon brush assembly for an electric tool.

(2) Description of the Prior Art

Under the same electric power supply and the same model and size, the lower the undue loss of electric energy due to conductance leakage or conductance resistance, the higher the electric power, the more the work can be done, and the wider the adaptability of the electric tool.

With the existing electric tools, those driven by electromagnetic force are widely used. In such a structure, a carbon brush disposed within the tool is biased against an electrically conductive carbon brush assembly. Referring to FIG. 1, a carbon brush seat 10 has a loop-shaped spring 20 disposed therein to bias against a carbon brush 40, which in turn abuts against a commutator 31 of an armature 30. In this structure, the electric conductance is affected by the biasing action of the spring 20. However, as is known, the biasing action of the spring 20 will suffer from elastic fatigue after prolonged subjection to pressure. Besides, the carbon brush 40 will also wear after a period of use and will cause the spring that has been deformed due to compression to extend as a result of accumulated elastic force. And the extended spring 20 weakens the elasticity thereof. Hence, after prolonged use of the electric tool, the force of the carbon brush 40 that pushes against the commutator 30 will diminish, so that the carbon brush 40 cannot tightly abut against the commutator 31. Besides, there are the following disadvantages:

1. The strength of the carbon brush that vertically abuts against the commutator cannot withstand the transverse pushing force produced by rotation of the commutator so that the conductive contact face of the carbon brush has faces of different obliquity due to change in rotational speed of the commutator, so that the contact face of the carbon brush becomes pointed. As a result, its contact with the surface of the commutator becomes a point contact instead of the original plane contact, thereby increasing contact resistance, which affects the conductance capability of the carbon brush and reduces the power of the electric tool.

2. After prolonged use, not only the contact face of the carbon brush will become small, the elasticity of the spring will also weaken. Besides, the deformed carbon brush will likely rub against the surface of the commutator to affect its roundness. As such, during high speed rotation, the commutator will push the carbon brush away, so that sparks are generated to affect conductance or even result in damage of components.

### SUMMARY OF THE INVENTION

Therefore, the object of the present invention is to provide an improved carbon brush assembly for an electric tool in which a constant force spring is insertably disposed in a carbon brush seat to bias against a carbon brush. By virtue of the constant force spring that can maintain a constant biasing force upon the carbon brush for a long period of time, even when the carbon brush is worn, the conductive contact face of the carbon brush can maintain vertical contact with a commutator and will not be readily brought to move by rotation of the commutator and to generate undue oblique frictional engagement. Hence, the surface of the commutator can maintain a plane contact with the carbon brush to thereby prolong the service life of the electric tool and to maintain the conductance capability of the carbon brush.

Another object of the present invention is to provide an improved carbon brush assembly for an electric tool, in which good plane contact between the carbon brush and the commutator can be maintained even after prolonged use so that the commutator is not likely to be worn to affect is roundness, thereby preventing generation of sparks or damage of components and ensuring conductance.

A further object of the present invention is to provide an improved carbon brush assembly for an electric tool, in which the housing of the electric tool is formed with a through hole for passage of the carbon brush. A sunken space is formed around the through hole for embedding the carbon brush. The outer edge wall of the sunken space can insertably receive the outer periphery of a cover such that the cover forms a part of the housing and shields the carbon brush seat. The cover is removable to permit removal and replacement of the carbon brush seat and carbon brush.

The foregoing objects and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The foregoing and other features and advantages of the present invention will be more clearly understood from the following detailed description and the accompanying drawings, in which,

FIG. 1 is a schematic view of a conventional carbon brush seat for an electric tool;

FIG. 2 is an exploded perspective view of an improved carbon brush assembly for an electric tool according to the present invention;

FIG. 3 is an exploded perspective view of the improved carbon brush assembly and a commutator;

FIG. 4 is an elevation view of the improved carbon brush assembly and the commutator; and

FIG. 5 is a sectional view of the improved carbon brush assembly and the commutator.

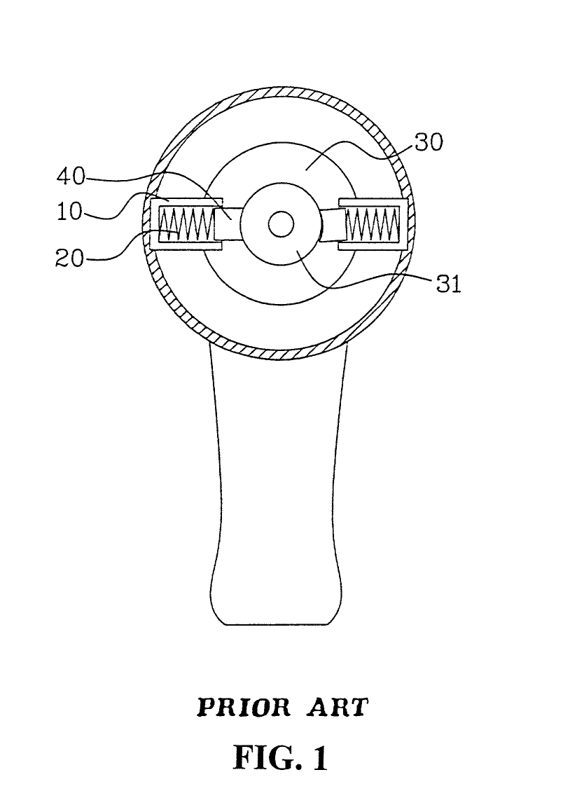

### DETAILED DESCRIPTION OF THE PREFERRED EMBODIMENT

For the purpose of promoting an understanding of the principles of the invention, reference will now be made to the embodiment illustrated in the drawings. Specific language will be used to describe same. It will, nevertheless, be understood that no limitation of the scope of the invention is thereby intended, alterations and further modifications in the illustrated device, and further applications of the principles of the invention as illustrated herein being contemplated as would normally occur to one skilled in the art to which the invention relates.

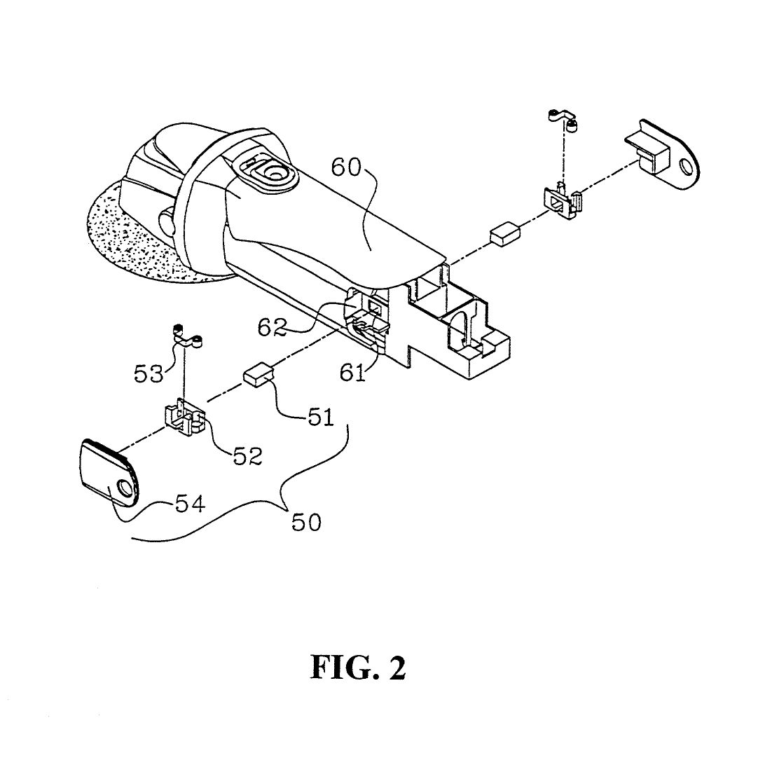

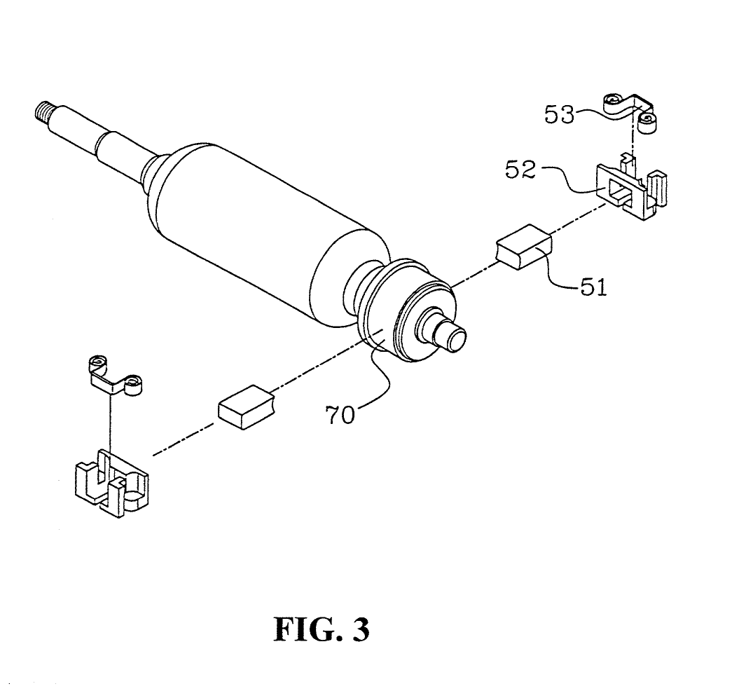

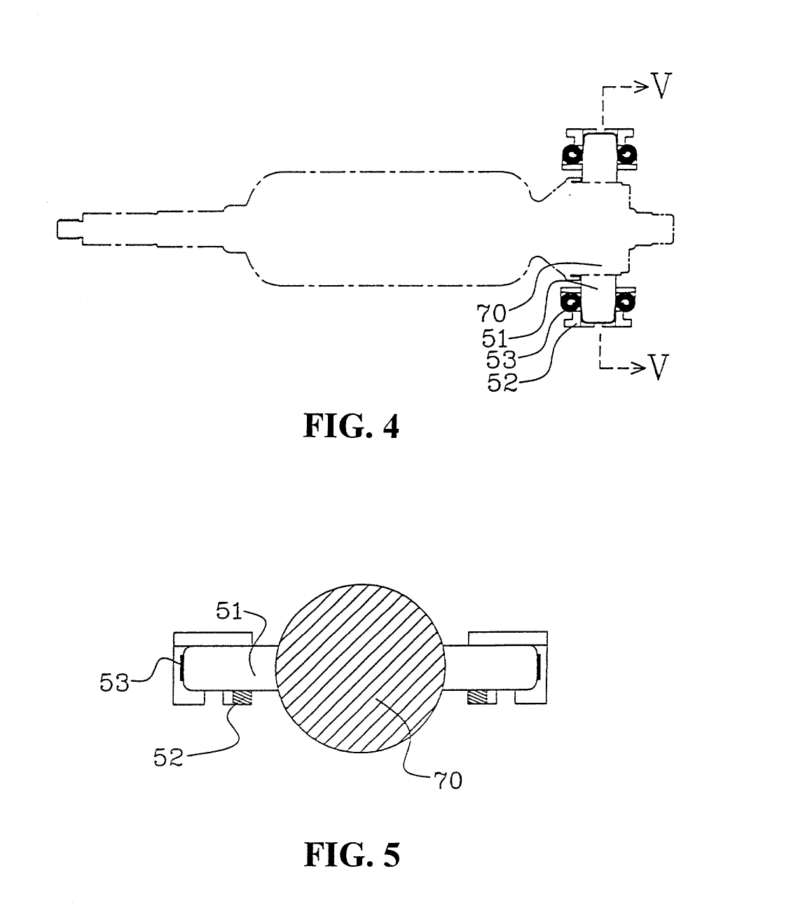

With reference to FIGS. 2 to 5, the preferred embodiment of an improved carbon brush assembly for an electric tool according to the present invention is directed to an improvement of a carbon brush assembly 50 for an electric tool that utilizes electromagnetic force to drive a tool shaft, such as a handheld electric grinding wheel device. As shown, the carbon brush assembly 50 includes a carbon brush 51, a carbon brush seat 52, a constant force spring 53 and a cover 54. The carbon brush seat 52 has the constant force spring 53 fitted therein. The carbon brush 51 always abuts against a plate portion of the constant force spring 53 in the carbon brush seat 52. An electric tool housing 60 is formed with a through hole 61 corresponding to the carbon brush seat 52 for passage of the carbon brush 51. A sunken space 62 is formed around the through hole 61 for embedding the carbon brush seat 52. The outer edge wall of the sunken space 62 may just insertably grip the edge of the cover 54 such that the cover forms a part of the housing 60 after assembly to shield the carbon brush seat 52 embedded in the housing 60. By virtue of the constant biasing force of the constant force spring 53, the service life of the carbon brush 51 can be extended and maintain the carbon brush 51 to be always in proper frictional contact with a commutator 70 in the housing to thereby eliminate poor electrical contact or generation of sparks. Furthermore, the cover 54 is movable to allow removal of the carbon brush seat 52 and the carbon brush 51 from the housing 60, thereby facilitating replacement of the carbon brush seat 52 and the carbon brush 51.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. An improved carbon brush assembly for an electric tool, particularly an electric tool utilizing electromagnetic force to drive a tool shaft, said electric tool having multiple carbon brush seats each comprising at least one carbon brush, one carbon brush seat and one constant force spring, said carbon brush seat having said constant force spring disposed therein, said carbon brush always abutting against a plate portion of said constant force spring in said carbon brush seat, said electric tool being formed with a through hole corresponding to said carbon brush seat for passage of said carbon brush, a sunken space being formed around said through hole for embedding said carbon brush seat.

2. An improved carbon brush assembly for an electric tool of claim 1, further comprising a cover, said sunken space having an outer edge wall projecting from said housing and capable of insertably gripping a periphery edge of said cover such that said cover forms a part of said housing after assembly and shields said carbon brush seat embedded in said housing.
